(19) United States
(12) Patent Application Publication
(10) Pub. No.: US 2001/0009853 A1
(43) Pub. Date: Jul. 26, 2001

(54) Method for selecting network system in mobile terminal and storsage medium storing program of same

(76) Inventor: Kazuhiro Arimitsu, Tokyo (JP)

Correspondence Address: McGuire Woods, 1750 Tysons Boulevard, Suite 1800, Tysons Conner, McLean, VA, 22102-4215, US

(21) Appl. No.: 09/750,907

(22) Filed: Jan. 2, 2001

(30) Foreign Application Priority Data
Jan. 7, 2000 (JP) 2000-002014

(51) Int. Cl. H04Q 7/20; H04M 1/00; H04B 1/38

(52) U.S. Cl. 455/434; 455/433; 455/552

(57) ABSTRACT

A method for a mobile terminal to select a network system which enables the mobile terminal to be connected through a radio channel to the network system desired by a user at a time the mobile terminal has to switch the network system being connected due to lowering in signal reception levels.

The method includes searching of other network systems by the mobile terminal having a list of other network systems and measuring signal reception levels provided by the other network systems, deciding of a new network system that can be used by the mobile terminal based on the signal reception levels and data on network systems desired by the user, providing reports about the decision to the network system being connected and switching the network system from the network system being now connected to the new network system designated by the network system in response to a request for switching.

### BACKGROUND OF THE INVENTION

1. Field of the Invention

The present invention relates to a method for a mobile terminal to select a network system which enables the mobile terminal to be automatically connected through a radio channel to a desired network system making up a network at a time of a hand-over operation of the mobile terminal and a storage medium storing a program of the method for the mobile terminal to select the network system.

The present application claims priority of Japanese Patent Application No.2000-002014 filed on Jan. 7,2000, which is hereby incorporated by reference.

2. Description of the Related Art

A mobile terminal such as a portable cellular phone or a like, by performing present-location registration with a mobile communication network system that the mobile terminal is using at present, is placed in an operating state, thus allowing the mobile terminal to be available for a telephone conversation; however, if the mobile terminal moves and is positioned at an end of a communication service area provided by the network system, a receiving electric field strength (that is, a signal reception level) of a signal sent by the network system decreases ordinarily. At this point, in a conventional network system, since a request for searching other network systems to find a new network system that the mobile terminal can use, in accordance with a protocol defined by an upper layer of the network system, is issued to the mobile terminal, the mobile terminal having received the request for searching other network systems performs a search for a new network system that can be connected through a radio channel. An item that the mobile terminal measures at this point is the signal reception level that other network systems can provide to the mobile terminal. The mobile terminal, after having measured the signal reception levels given by other network systems, notifies original network system of data about other network systems that can provide the signal reception level being higher than a specified level. The original network system having received the data on the signal reception level from the mobile terminal judges whether the mobile terminal should switch the network system from a present network system to new network system. When the original network system judges that the mobile terminal should switch the network system to the new network system, the original network system issues a request for switching the network system to the mobile terminal and, in response to this request signal, the mobile terminal is connected through the radio channel to the new network system and then continues communicating operations under control of the new network system.

Conventional operations between the network system and the mobile terminal will be described in further detail below by referring to FIG. 5 to FIG. 8. FIG. 5 is a schematic block diagram showing an example of configurations of the mobile terminal used in the conventional operations. FIG. 6 is a schematic block diagram showing a general configuration of a conventional mobile communication network including network systems. FIG. 7 is a flowchart illustrating conventional procedures for switching network systems taken by the mobile terminal. FIG. 8 is a table showing data about signal reception levels provided conventionally by network systems that can be used by the mobile terminal.

As shown in FIG. 5, the mobile terminal used in the conventional operations chiefly includes a radio section 1, a control section 2, a CPU (Central Processing Unit) section 3, a memory section 4 and a battery 5. The radio section 1 receives and/or sends data signals and control signals in form of radio signals to and from the network system and measures reception levels of signals received from the network systems. The control section 2 controls the switching of network systems in the radio section 1 and inputs and/or outputs data signals and/or control signals. The data signals and/or control signals that are input to the control section 2 contain requests for searching other network systems to find a new network system and for switching the network system to the searched new network system to which the mobile terminal is connected, which the radio section 1 have received from the network system, and results of measurement of signal reception levels performed by the radio section 1. Control data that are output from the control section 2 contain data about signal reception levels to be sent through the radio section 1 to the network system when the signal reception level drops below a specified value during communications and data about priorities assigned to the network systems that is reported by the CPU section 3 to the network system. The CPU section 3, after the network system having issued a request for searching for the new network system, receives measured results of the signal reception levels provided by a plurality of other network systems and creates, based on received results, a system level table showing priorities decided by the mobile terminal based on the strength of signal reception levels provided by other network systems and a kind of each of the other network systems and signal reception levels provided by the other network systems (see FIG. 8) and then feeds the system level table to the control section 2. The memory section 4 stores programs required for operations of an entire mobile terminal, data for control or a like and also stores data about telephone or address directories or a like. The battery 5 supplies power required for operations of each part making up the mobile terminal.

As shown in FIG. 6, the mobile communication network is made up of a plurality of network systems 12₁, 12₂, . . . , 12ₙ, each being connected through a radio channel to each of a plurality of mobile terminals 11. Each of the mobile terminals 11 has configurations as shown in FIG. 5. Each of the network systems 12₁, 12₂, . . . , 12ₙ has a different communication type.

A representative example of configurations of the network systems 12₁, 12₂, . . . , 12ₙ is reoresented in the network system 12, shown in FIG. 6, which is made up of a radio section 13, a control section 14, a line connecting section 15 and an upper layer 16. The radio section 13 sends or receives data signals and control signals through the radio channel to and from the mobile terminal 11. The control section 14 sends or receives various control data required for operations of the network system 12₁ to and from the radio section 13 and also receives measured results of signal reception levels from the mobile terminal 11 and sends out a request for switching the network system to the mobile terminal 11. The line connecting section 15 sends or receives data signals and control signals through the control section 14, the radio section 13 and through the radio channel to and from the mobile terminal 11 or through a wire circuit to and from other terminals. The upper layer 16 judges whether a request for searching for the new network system that can be used by the mobile terminal 11 should be issued or not based on measured results, received through the radio section 13, of reception level of signals that the mobile terminal 11 is receiving and, if it is judged that the request for searching network systems is required, sends out the request through the radio section 13 to the mobile terminal 11.

Conventional operations of selecting the network system in the mobile terminals are explained by referring to FIG. 5 to FIG. 8.

When data indicating lowered signal reception levels is sent from a mobile terminal 11 to the network system, the upper layer 16 of the network system to which the mobile terminal 11 is connected issues a request for searching for a network system that can be newly connected to the mobile terminal 11 (see Step S301 in FIG. 7). The mobile terminal 11 that has received the request for searching performs a search for the new network system (Step S302 in FIG. 7). An item that the mobile terminal 11 measures at point is signal receiving electric field levels that other network systems can provide. The mobile terminal 11 measures signal reception levels of other specified network systems (Step S303 in FIG. 7) and decides priorities to be assigned to other network systems based on the strength of signal reception levels provided by the network systems (Step S304 in FIG. 7) and then notifies the network system of decisions as results of the search (Step S305 in FIG. 7). The network system having received the reports about search results judges whether the mobile terminal 11 should switch the network system to any other network system or not and, if it judges that the mobile terminal 11 should switch, issues a request for switching the network system to the mobile terminal 11. The mobile terminal 11, when receiving the request for switching the network system (Step S306 in FIG. 7), performs switching the network system from the present network system to new network system designated by the network system (Step S307 in FIG. 7) and continues communication operations under control of the new network system (Step S308 in FIG. 7). The mobile terminal 11, when not receiving the request for switching (Step S306 in FIG. 7), continues communication operations under the control of the present network system.

As shown in FIG. 8, report about search results sent from the mobile terminal 11 contains priorities (1 to 5) decided by the mobile terminal 11 based on the strength of signal reception levels, a kind of each of other network systems (A to E) and signal reception levels (a1 to a5). The network system having received the report designates the system B having a high priority as a network system to which the mobile terminal 11 is connected and issues a request for switching the network system, and the mobile terminal 11 executes switching of the network system from the present network system to the network system B.

However, the conventional method for selecting the network system in the mobile terminal 11 has a problem in that it is impossible for the mobile terminal 11 to be connected to a network system desired by a user. Moreover, it has another problem in that, when the mobile terminal 11 switches the network system from the present network system to a new network system, a service that had been provided by the previous network system cannot be continued, in that it is impossible to allow a selection of the new network system that can provide cheaper connection fees and in that it is impossible to allow the selection of the new network system that consumes less power.

### SUMMARY OF THE INVENTION

In view of the above, it is an object of the present invention to provide a method for a mobile terminal to select a network system which enables the mobile terminal to be connected to a network system desired by a user, which enables the mobile terminal to continue to receive common services from the network system to which the mobile terminal had been connected before a hand-over operation, which enables the mobile terminal to select the network system that can provide cheaper connection fees and which enables the mobile terminal to be connected to the network system which consumes less power, and to provide a storage medium storing a program of the above method for the mobile terminal to select the network system.

According to a first aspect of the present invention, there is provided a method for a mobile terminal being operable in network systems of a plurality of communication types each being different from each other to select the network system to be employed when the mobile terminal having a list of other network systems to one of which the mobile terminal desires to be connected in a radio channel receives a request for searching other network systems being usable from the network system being now connected due to lowering in signal reception levels provided by the network system being now connected, including:

a step of measuring signal reception levels provided by the other network systems and deciding the network system that is connectable to the mobile terminal based on the measured signal reception levels and on data about network systems that are desired to be connected, providing a report about decisions made by the mobile terminal to the network system being now connected; and

a step of switching the network system being now connected to a new designated network system in response to a request for switching the network system being now connected.

In the foregoing, a preferable mode is one wherein priorities are assigned to other network systems, contained in the list, to which a user desires the mobile terminal to be connected.

Also, a preferable mode is one wherein the list contains the other network systems that are able to provide common services to the mobile terminal.

Also, a preferable mode is one wherein the list contains the other network systems that are able to provide cheaper connection fees and the other network systems are listed in order of providing cheaper connection fees.

Also, a preferable mode is one wherein the list contains the other network systems to which the mobile terminal desires to be connected and the other network systems are listed in order of consuming less power.

Also, a preferable mode is one that wherein includes a step of deciding the usable system by selecting from the list containing other network systems to which the mobile terminal desires to be connected when other network system having a reception level being higher a specified threshold value is to be selected and of deciding the usable system by selecting in accordance with orders of the signal reception level when other network system having the reception level not reaching the specified threshold value is to be selected.

According to a second aspect of the present invention, there is provided a storage medium storing program to cause a computer to execute a method by which a mobile terminal being operable in network systems of a plurality of communication types each being different from each other, selects a network system, the method including:

a step of preparing a list containing other network systems to which the mobile terminal desires to be connected,

a step of measuring signal reception level of other network systems when the mobile terminal receives the request for searching other network systems being usable from a network system being now connected due to lowering in signal reception levels in the mobile terminal and of deciding a usable network system based on the signal reception levels of other network systems and on data about network systems to which the mobile terminal desires to be connected and of reporting to the network system being now connected and

a step of switching to designated other network system in response to a request for switching the network system fed from the network system being now connected.

With the above configuration, when the mobile terminal switches the network system in response to the request for switching the network system due to lowering in signal reception levels, it is possible to switch the network system to a new network system that is desired by a user.

With another configuration as above, since it is possible for the mobile terminal to switch the network system to a new network system that can provide a service being commonly supplied by a previous network system, probability of occurrence of call termination can be reduced.

With still another configuration as above, since it is possible for the mobile terminal to switch the network system to a new network system that can provide cheaper connection fees, expenses for communications can be saved.

With still another configuration as above, since it is possible for the mobile terminal to switch the network system to a new network system that consumes less power, standby time of the mobile terminal and duration of telephone communications can be made longer.

### BRIEF DESCRIPTION OF THE DRAWINGS

The above and other objects, advantages and features of the present invention will be more apparent from the following description taken in conjunction with the accompanying drawings in which:

FIG. 1 is a flowchart showing procedures for switching network systems in a mobile terminal according to a first embodiment;

FIG. 2 is a table showing priorities assigned to network systems that are desired by a user in selecting network systems in the mobile terminal employed in methods according to the first embodiment;

FIG. 3 is a table showing priorities assigned to network systems that are decided in selecting network systems in the mobile terminal employed in methods according to the first embodiment;

FIG. 4 is a flowchart showing a method for deciding priorities to be assigned to network systems, with considerations given to desired priorities assigned to network systems, in selecting network systems in the mobile terminal according to the first embodiment;

FIG. 5 is a schematic block diagram showing an example of configurations of a mobile terminal used in conventional procedures for switching network systems;

FIG. 6 is a schematic block diagram showing a general configuration of a mobile communication network used in conventional methods for switching network systems;

FIG. 7 is a flowchart illustrating conventional procedures for switching network systems by the mobile terminal; and

FIG. 8 is a table showing reported data on network systems that can be used by the mobile terminal used in conventional procedures for switching network systems.

### DETAILED DESCRIPTION OF THE PREFERRED EMBODIMENTS

Best modes of carrying out the present invention will be described in further detail using various embodiments with reference to the accompanying drawings.

### First Embodiment

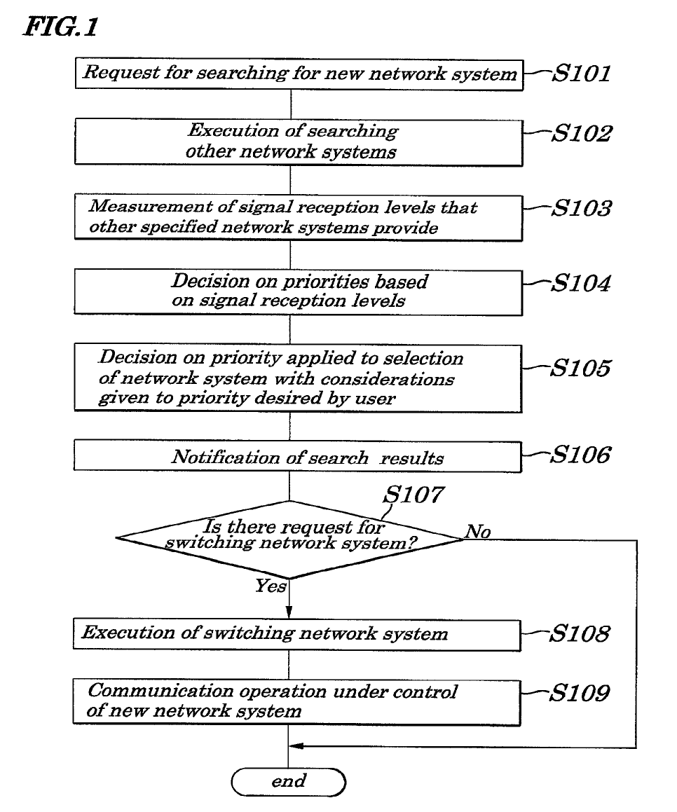

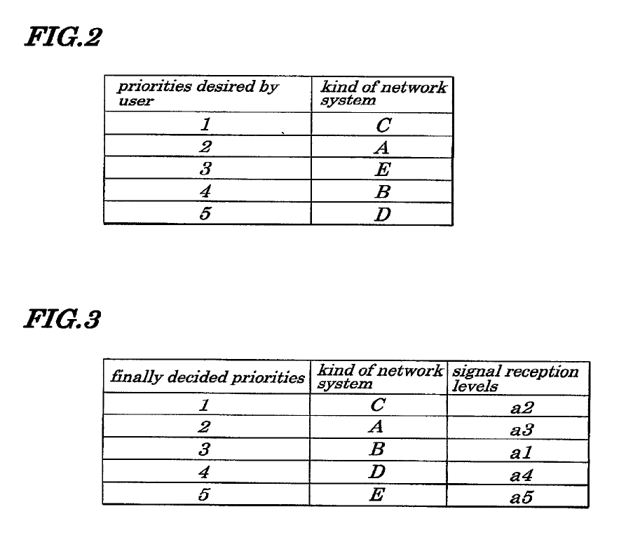

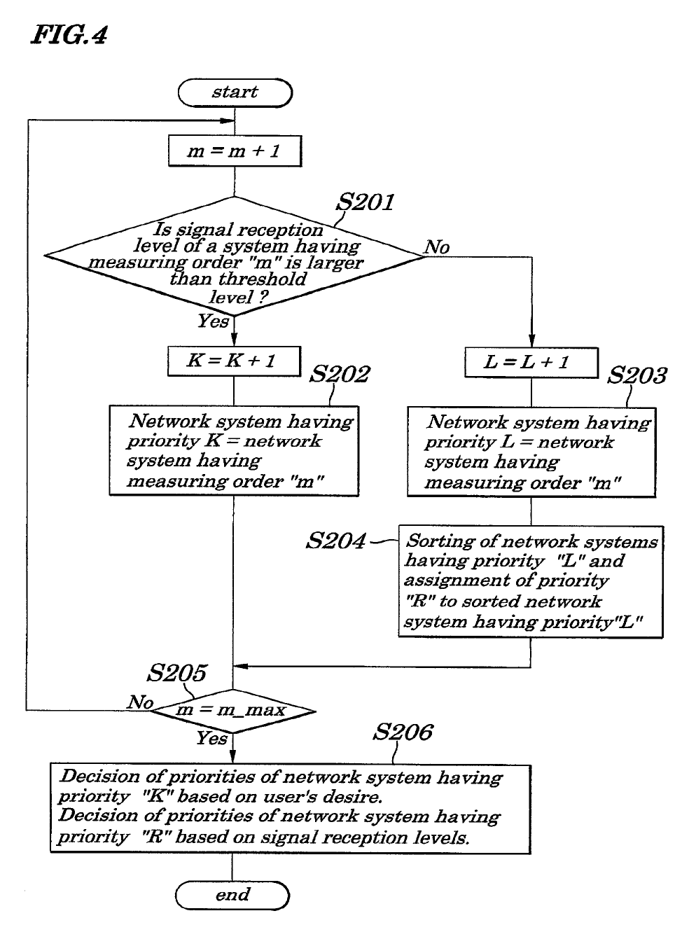

FIG. 1 is a flowchart showing procedures for switching network systems in a mobile terminal employed in methods according to a first embodiment. FIG. 2 is a table showing priorities assigned to network systems that are desired by a user in selecting network systems in the mobile terminal employed in methods according to the first embodiment. FIG. 3 is a table showing priorities assigned to network systems that are decided in selecting network systems in the mobile terminal employed in methods according to the first embodiment. FIG. 4 is a flowchart showing a method for deciding priorities to be assigned to network systems, with considerations given to priorities assigned to network systems desired by the user, in selecting network systems in the mobile terminal according to the first embodiment.

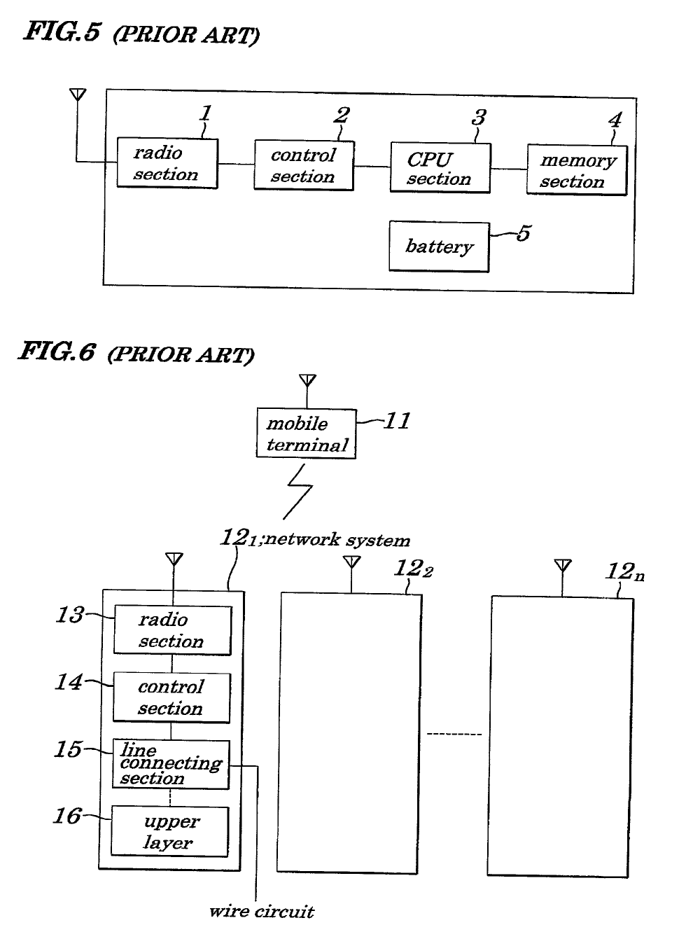

Configurations of the mobile terminal of the first embodiment are almost same as those shown in FIG. 5, however, they differ from those in FIG. 5 in that a memory section 4 stores data on priorities assigned to network systems desired by the user which is referenced to when the mobile terminal switches the network system to a new network system and a CPU section 3 decides, when receiving measured results of signal reception levels, priorities assigned to network systems with considerations given to the priorities desired by the user.

Operations of switching network systems in the mobile terminal of the embodiment will be explained below by referring to FIG. 1 to FIG. 4.

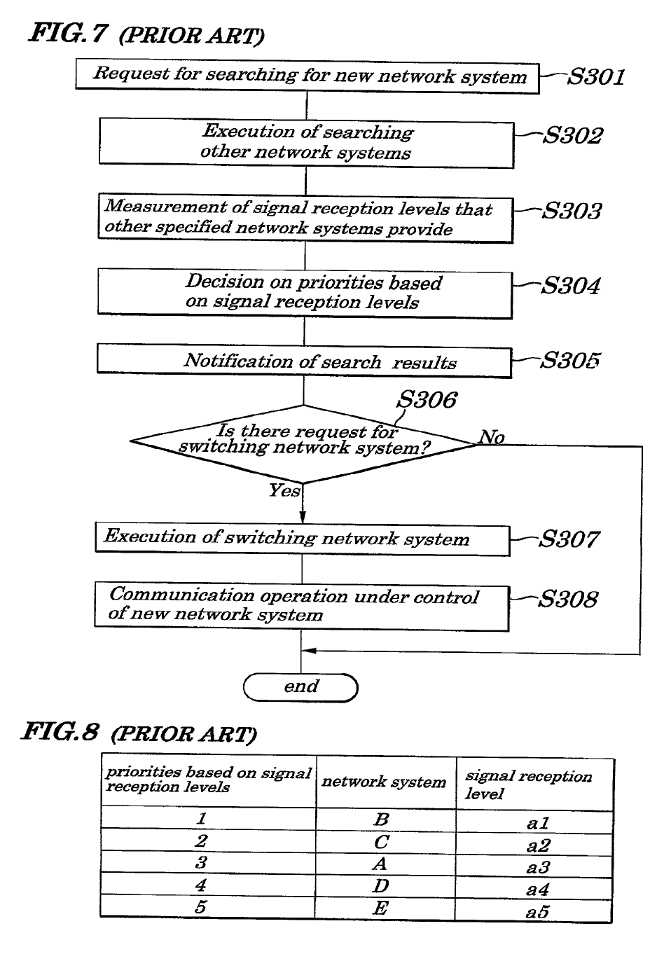

When the network system to which the mobile terminal is being connected at present receives a report from the mobile terminal that reception level of signals that the mobile terminal is receiving is lowered, a request for searching other network systems to find the new network system, in accordance with a protocol of an upper layer of the network system to which the mobile terminal is being connected, is issued to the mobile terminal (Step S101 in FIG. 1). The mobile terminal that has received the request for searching other network systems executes searching (Step S102 in FIG. 1). An item that the mobile terminal measures at this point is signal receiving electric field levels that the other network systems can provide. The mobile terminal measures signal reception levels provided by the other network systems (Step S103 in FIG. 1) and decides priorities based on strength of signal reception levels provided by the other network systems (Step S104 in FIG. 1). Procedures described above are same as those in the conventional method shown in FIG. 7.

Next, the mobile terminal decides priorities to be applied to selection of network systems with considerations given to priority desired by the user being stored in the memory section 4; that is, the mobile terminal decides the priority by assigning the priority desired by the user to the network system having a level being higher than a specified threshold level and by assigning the above priority decided based on the strength of signal reception levels to the network system having the level being lower than the specified threshold level (Step S105 in FIG. 1), and notifies this decision as a result of searching (Step S106 in FIG. 1) to the network system. The network system having received reports about search results judges whether the mobile terminal should switch the network system to any other network system or not and, if the network system judges it proper to switch the network system being now connected, issues a request for switching the network system being used to the mobile terminal. The mobile terminal, when receiving a request for switching the network system (Step S107 in FIG. 1), performs switching of the network system from the present network system to new network system designated by the network system being used (Step S108 in FIG. 1) and thereafter continues communicating operations under control of the new network system (Step S109). The mobile terminal, when not receiving the switching request, continues previous operations (Step S107 in FIG. 1).

The priorities (1-5) shown in FIG. 8 are those decided by the mobile terminal based on the strength of signal reception levels (a1 to a5) provided by the network systems (A to E), and measured and assigned by the radio section 1 of the mobile terminal. On the other hand, data on the priority desired by the user is stored in the memory section 4 as shown in FIG. 2. That is, the priorities (1 to 5) are assigned, in advance, by the user to network systems A to E to be connected by the mobile terminal.

The CPU section 3 of the mobile terminal finally creates a table showing priorities to be applied to selection of the new network system by using both priorities decided on basis of strength of signal reception levels as shown in FIG. 8 and priorities desired by the user as shown in FIG. 2; that is, for example, the signal reception level “a3” as shown in FIG. 8 is used as a threshold level and the priorities desired by the user as shown in FIG. 2 are assigned to the network systems B, C and A having the signal reception levels being higher than the threshold level a3 and the orders to be applied to the selection are finally decided to be C, A and B. Then, the priorities decided on the basis of the strength of signal reception levels as shown in FIG. 8 are assigned to network systems D and E having the signal reception levels being lower than the threshold level a3, as in the case of the conventional method, and the orders to be applied to the selection are finally decided to be D and E. Therefore, the finally decided orders are C, A, B, D, and E in order as shown in a table in FIG. 3. This decision is notified, as a search result, to the network system being connected at present.

Procedures for deciding the priorities to be assigned to the network systems, with consideration given to the priorities desired by the user, will be described below by referring to a flowchart shown in FIG. 4. First, a possibility of network systems, out of a plurality of network systems, having measuring order “m” being selected as the network system to which the mobile terminal is connected is judged by confirming as to whether the signal reception levels provided by the network systems having the measuring order “m” are higher than the threshold level (a reference level) (Step S201 in FIG. 4). Only network systems having the signal reception level being higher than the threshold level are extracted and a priority “K” is assigned to all the network systems having the signal reception level being higher than the threshold (Step S202 in FIG. 4). On the other hand, only network systems having the signal reception level being lower than the threshold level are extracted and a priority “L” is assigned to all the network systems having the level being lower than the threshold level (Step S203 in FIG. 4) and then all the network systems having the priority “L” are sorted so that order of the network systems with the priority “L” are re-arranged in a manner that the priority is decided on basis of strength of signal reception levels as shown in FIG. 8 (Step S204 in FIG. 4) and new priority “R” is assigned to sorted network systems. The same procedures as above are performed on all network systems having the measuring order “m” (Step S205 in FIG. 4). Finally priorities of network systems having the priority K are decided on the basis of desire of the user in the same manner as shown in FIG. 2 and priorities of network systems having the priority R, are decided on the basis of the strength of signal reception level in the same manner as shown in FIG. 8 (Step S206 in FIG. 4).

Thus, according to the first embodiment, when the mobile terminal switches the network system to a new network system, since not only the priority decided on the basis of the strength of signal reception levels provided by other network systems but also the priority decided on the basis of the desire of the user are notified, the network system is selected with consideration given to the priority desired by the user, that is, the mobile terminal can be connected to the new network system desired by the user.

### Second Embodiment

Configurations of a mobile terminal employed in a method of a second embodiment are almost same as those in the first embodiment, however, the mobile terminal in the second embodiment differs greatly from that in the first embodiment in that a memory section 4 is adapted to store, instead of the priorities desired by a user, contents of two or more network systems that can provide common services to the user and that a CPU section 3, when deciding priorities to be used at a time of selection of a network system to which the mobile terminal is to be connected based on measured results of signal reception levels, is adapted to use the above contents of two or more network systems stored in the memory section 4.

In the second embodiment, as in the case of the first embodiment, the mobile terminal, when receiving a request for searching other network systems that can be connected by the mobile terminal in accordance with a protocol of an upper layer of the network system being connected, measures signal reception levels provided by other network systems. When there are network systems having the signal reception level being higher than a specified threshold level, the mobile terminal checks as to whether the network systems having the signal reception level being higher than the specified threshold level are contained in the network systems stored in the memory section 4 and, if they exist, chooses the network systems contained in the memory section 4. In the case of network systems having the signal reception level being lower than the specified threshold level, the network systems are selected in order of strength of the signal reception level and priority to be assigned to the network systems is decided by the mobile terminal based on the strength of the signal reception level in a same format as shown in FIG. 3. The mobile terminal notifies the network system of result.

The network system having received the result, when judging it proper for the mobile terminal to switch the network system, issues a request for switching the network system to the mobile terminal and, in response to this request, the mobile terminal executes switching of the network system from present network system to a new network system designated by the network system and stored in the memory section 4, allowing the mobile terminal to continue to receive common services from the network system to which the mobile terminal had been connected before a hand-over operation.

Thus, according to the second embodiment, since the mobile terminal selects network systems that can provide common services, service that the mobile terminal had been receiving can be supplied continuously and probability of occurrence of call termination can be lowered.

### Third Embodiment

Configurations of a mobile terminal employed in a method of a third embodiment are almost same as those in the first embodiment, however, the mobile terminal in the third embodiment differs greatly from that in the first embodiment in that a memory section 4 stores, instead of priorities desired by a user, contents of two or more network systems listed in order of providing cheaper connection fees and that a CPU section 3, when deciding priorities to be used at a time of selection of a network system to which the mobile terminal is to be connected based on measured results of signal reception levels, is adapted to use contents of two or more network systems listed in order of providing cheaper connection fees, stored in the memory section 4.

In the third embodiment, as in the case of the first embodiment, the mobile terminal, when receiving a request for searching other network systems that can be connected by the mobile terminal in accordance with a protocol of an upper layer of a network system being now connected, measures signal reception levels provided by other network systems. When there are network systems having the signal reception level being higher than the specified threshold level, the mobile terminal checks as to whether the network systems having the signal reception level being higher than the specified threshold level are contained in the network systems listed in order of providing cheaper connection fees, stored in the memory section 4 and, if they exist, chooses the network systems contained in the memory section 4. In the case of network systems having the signal reception level being lower than the specified threshold level, the network systems are selected in order of strength of the signal reception level and priority to be assigned to the network systems is decided by the mobile terminal based on the strength of the signal reception level in same format as shown in FIG. 3.

The network system having received the result, when judging it proper for the mobile terminal to switch the network system, issues a request for switching the network system to the mobile terminal and in response to this request, the mobile terminal executes switching of the network system from present network system to a new network system designated by the network system and stored in the memory section 4, allowing the mobile terminal to be connected to the network system that can provide cheapest connection fees and to continue communications.

Thus, according to the third embodiment, since the mobile terminal issues the result about network systems that can be connected by the mobile terminal with considerations given to the network systems that can provide cheaper connection fees, the mobile terminal can perform switching the network system so that expenses for connection fees can be reduced.

### Fourth Embodiment

Configurations of a mobile terminal employed in a method of a fourth embodiment are almost same as those in the first embodiment, however, the mobile terminal in the fourth embodiment differs greatly from that in the first embodiment in that memory section 4 stores, instead of priorities desired by a user, contents of two or more network systems listed in order of consuming less power and that a CPU section 3, when deciding priorities to be used at a time of selection of a network system to which the mobile terminal is to be connected based on measured results of signal reception levels, is adapted to use the above contents of two or more network systems listed in order of consuming less power, stored in the memory section 4.

In the fourth embodiment, as in the case of the first embodiment, the mobile terminal, when receiving a request for searching other network systems that can be connected by the mobile terminal in accordance with a protocol of an upper layer of a network system being now connected, measures signal reception levels provided by other network systems. When there are network systems having the signal reception level being higher than a specified threshold level, the mobile terminal checks as to whether the network systems having the signal reception level being higher than the specified threshold level are contained in the network systems listed in order of consuming less power, stored in the memory section 4 and, if they exist, chooses the network systems contained in the memory section 4. In the case of network systems having the signal reception level being lower than the specified threshold level, the network systems are selected in order of strength of the signal reception level and priority to be assigned to the network systems is decided by the mobile terminal based on the strength of the signal reception level in same format as shown in FIG. 3.

The network system having received the result, when judging it proper for the mobile terminal to switch the network system, issues a request for switching the network system to the mobile terminal and, in response to this request, the mobile terminal executes switching of the network system from present network system to new network system designated by the network system and stored in the memory section 4, allowing the mobile terminal to be connected to the network system consuming least power and to continue communications.

Thus, according to the fourth embodiment, since the mobile terminal provides the result about network systems that can be connected by the mobile terminal with considerations given to the network systems that consume less power, the mobile terminal can perform switching the network system so that power consumption can be reduced and standby time and duration of a telephone communication can be made longer accordingly.

It is apparent that the present invention is not limited to the above embodiments but may be changed and modified without departing from the scope and spirit of the invention. For example, in the above embodiments, when the network system issues the request for switching the network system to the mobile terminal, the network system being now connected designates the new network system to be switched to, however, the mobile terminal itself may select the network system from those that the mobile terminal has notified the network system in response to the request and may switches the network system from the present network system to the new network system that the mobile terminal has selected. Also, in the above embodiments, the new network system to which the mobile terminal switch the network system, in accordance with designation or without the designation, is ordinarily the network system ranked to be the first in decided priorities, however, a method in which the network system ranked to be the second or below is selected by giving some limitations may be used. Moreover, in the above embodiment, when the signal reception levels are measured and there are network systems having the signal reception level being higher than a specified threshold level, the mobile terminal checks as to whether the network systems having the signal reception level being higher than the specified threshold level are contained in the network systems stored in the memory section and, if they exist, chooses the network systems contained in the memory section and, in the case of network systems having the signal reception level being lower than the specified threshold level, the network systems are selected in order of strength of the signal reception level and priority to be assigned to the network systems is decided by the mobile terminal based on the strength of the signal reception level, however, a method in which all network systems are selected from those stored in the memory section, irrespective of the threshold level, may be available.

Furthermore, the method for selecting the network system by the mobile terminal according to the present invention may be executed by loading a program, stored in a computer-readable storage medium, for implementing this method in the memory section and causing the CPU section to operate in accordance with the program. As the computer-readable storage medium, a variety of semiconductor memories, disk memories, or like may be used.

What is claimed is:

1. A method for a mobile terminal being operable in network systems of a plurality of communication types each being different from each other to select a network system to be employed when said mobile terminal having a list of other network systems to one of which said mobile terminal desires to be connected in a radio channel receives a request for searching other network systems being usable from said network system being now connected due to lowering in signal reception levels provided by said network system being now connected, said method comprising:
a step of measuring signal reception levels provided by said other network systems and deciding a network system that is connectable to said mobile terminal based on said measured signal reception levels and on data about network systems that are desired to be connected, providing a report about decisions made by said mobile terminal to said network system being now connected; and
a step of switching said network system being now connected to a new designated network system in response to a request for switching said network system being now connected.

2. The method for the mobile terminal to select a network system according to claim 1, wherein priorities are assigned to said other network systems, contained in said list, to which a user desires said mobile terminal to be connected.

3. The method for the mobile terminal to select a network system according to claim 1, wherein said list contains said other network systems that are able to provide common services to said mobile terminal.

4. The method for the mobile terminal to select a network system according to claim 1, wherein said list contains said other network systems that are able to provide cheaper connection fees and said other network systems are listed in order of providing said cheaper connection fees.

5. The method for the mobile terminal to select a network system according to claim 1, wherein said list contains said other network systems to which said mobile terminal desires to be connected and said other network systems are listed in order of consuming said less power.

6. The method for the mobile terminal to select a network system according to claim 1, further comprising a step of deciding said usable system by selecting from said list containing said other network systems to which said mobile terminal desires to be connected when other network system having a reception level being higher a specified threshold value is to be selected and of deciding said usable system by selecting in accordance with orders of said signal reception level when other network system having said reception level not reaching said specified threshold value is to be selected.

7. The method for the mobile terminal to select a network system according to claim 2, further comprising a step of deciding said usable system by selecting from said list containing said other network systems to which said mobile terminal desires to be connected when other network system having a reception level being higher a specified threshold value is to be selected and of deciding said usable system by selecting in accordance with orders of said signal reception level when other network system having said reception level not reaching said specified threshold value is to be selected.

8. The method for the mobile terminal to select a network system according to claim 4, further comprising a step of deciding said usable system by selecting from said list containing said other network systems to which said mobile terminal desires to be connected when other network system having a reception level being higher a specified threshold value is to be selected and of deciding said usable system by selecting in accordance with orders of said signal reception level when other network system having said reception level not reaching said specified threshold value is to be selected.

9. The method for the mobile terminal to select a network system according to claim 5, further comprising a step of deciding said usable system by selecting from said list containing said other network systems to which said mobile terminal desires to be connected when other network system having a reception level being higher a specified threshold value is to be selected and of deciding said usable system by selecting in accordance with orders of said signal reception level when other network system having said reception level not reaching said specified threshold value is to be selected.

10. A storage medium storing program to cause to a computer to execute a method by which a mobile terminal being operable in network systems of a plurality of communication types each being different from each other, selects a network system, said method comprising:
a step of preparing a list containing other network systems to which said mobile terminal desires to be connected,
a step of measuring signal reception level of other network systems when said mobile terminal receives said request for searching other network systems being usable from a network system being now connected due to lowering in signal reception levels in said mobile terminal and of deciding a usable network system based on said signal reception levels of other network systems and on data about network systems to which said mobile terminal desires to be connected and of reporting to said network system being now connected and
a step of switching to designated other network system in response to a request for switching said network system fed from said network system being now connected.
